(19) United States
(12) Patent Application Publication
(10) Pub. No.: US 2021/0369522 A1
(43) Pub. Date: Dec. 2, 2021

(54) PATIENT APPARATUS WITH TOUCHSCREEN

(71) Applicant: Stryker Corporation, Kalamazoo, MI (US)

(72) Inventors: Kurosh Nahavandi, Portage, MI (US); Placide Nibakuze, Kalamazoo, MI (US); David Buick, Portage, MI (US); Alexey Titov, Redmond, WA (US)

(21) Appl. No.: 17/286,680

(22) PCT Filed: Dec. 17, 2019
(86) PCT No.: PCT/US2019/066811

§ 371 Date: Apr. 19, 2021

Related U.S. Application Data
(60) Provisional application No. 62/783,445, filed on Dec. 21, 2018.

(51) Int. Cl. A61G 7/05; A61G 7/10

(52) U.S. Cl. CPC A61G 7/0524; A61G 7/108; A61G 2203/30; A61G 2203/20; A61G 2203/16

(57) ABSTRACT

A patient support apparatus, such as a bed, cot, stretcher, operating table, recliner, or the like, includes a litter frame, a support deck, a user interface having a touchscreen and a controller configured carrying out various functions and to display various screens on the touchscreen. When user input to control the litter frame or support deck is received, the controller is configured to add a numeric indicator representative of the position of the litter frame or support deck to the screen. When a user input to carry out a function for which the apparatus is not in an acceptable state, the controller is configured to notify the user of this error and provide a control for remedying the error on the touchscreen. The controller is further configured to provide multiple levels of help information on the screen.

### CROSS-REFERENCE TO RELATED APPLICATIONS

This application claims priority to U.S. provisional patent application Ser. No. 62/783,445 filed Dec. 21, 2018, by inventors Kurosh Nahavandi et al. and entitled PATIENT SUPPORT APPARATUS WITH TOUCHSCREEN, the complete disclosure of which is incorporated herein by reference.

### BACKGROUND

The present disclosure relates to patient support apparatuses, such as beds, cots, stretchers, operating tables, recliners, or the like. More specifically, the present disclosure relates to patient support apparatuses that include user interfaces for controlling one or more components or systems of the patient support apparatus.

Conventional patient support apparatuses comprise a base, a litter frame, a support deck on the litter frame upon which the patient is supported, a lift system for lifting and lowering the support deck relative to the base, and an articulation system for articulating one or more sections of the support deck. Control of these and other systems of the patient support apparatus is performed via a user interface provided on a footboard or on one or more of the side rails of the patient support apparatus. Often, operation of the user interface is complex, making the user interface difficult to operate.

### SUMMARY

According to various embodiments, an improved patient support apparatus is provided that includes a touchscreen user interface. In its various embodiments, the present disclosure provides a patient support apparatus having a user interface that is easy to navigate via a touchscreen. In some embodiments, information and/or controls automatically appear when helpful and/or necessary, saving space on the touchscreen until the information or controls are needed by the user, and also providing a streamlined user experience. The need to navigate manually between different screens in order to accomplish a desired task is also reduced, thereby reducing the effort needed to accomplish the desired task and the chances of becoming lost and/or sidetracked when navigating through the various screens of the user interface. These and/or other features are disclosed in the various embodiments discussed herein.

According to one embodiment of the present disclosure, a patient support apparatus is provided that includes a litter frame, a support deck, an actuator adapted to move a component of the patient support apparatus, a sensor adapted to detect a configuration of the component, a touchscreen, and a controller configured to receive readings from the sensor. The controller is configured to generate a first control screen and a second control screen, wherein the first control screen includes a first control icon for controlling the component and the second control screen includes a second control icon for controlling a function. In response to a user selecting the second control icon, the controller is configured to determine if a current configuration of the component is in an acceptable state or an unacceptable state for carrying out the function. If the controller determines the component is currently in the unacceptable state, the controller is further configured to display a third control icon that allows the user to move the component to the acceptable state without accessing the first control screen.

According to some embodiments, the function is at least one of: weighing a patient supported on the support deck, turning a patient supported on the support deck, or lateral rotation of a patient supported on the support deck. In some embodiments, the controller is configured to prevent the function if the component is in the unacceptable state and permit the function if the component is in an acceptable state.

In at least one embodiment, the third control icon comprises a one-touch input control for moving the component to the acceptable state.

The controller is further configured, in at least some embodiments, to display the third control icon in a pop-up window, wherein second control screen is at least partially visible behind the pop-up window, or to display the third control icon on a third control screen, different from the first and second control screens.

According to another embodiment of the present disclosure, a patient support apparatus is provided that includes a litter frame, a support deck, a touchscreen, and a controller. The controller is configured to display a first screen at the touchscreen, the first screen including a first icon and a help icon. The controller is further configured to display an explanation overlay at the touchscreen in response to user-selection of the help icon. The explanation overlay comprises text explaining the first icon and is partially transparent such that the first screen is at least partially visible under the explanation overlay while the controller is displaying the explanation overlay.

In some embodiments, the first icon controls a component or a function of the patient support apparatus, and the controller is configured to disable the first icon if the explanation overlay is displayed at the touchscreen.

In some embodiments, the controller is further configured to overlay the text explaining the first icon on the first icon.

In some embodiments, the first screen comprises an additional icon, and the explanation overlay comprises text explaining the additional icon that is simultaneously displayed with the text explaining the first icon.

The first screen is a bed monitor screen in at least some embodiments, including a control for arming a bed monitoring function, the bed monitor function adapted to monitor a selected state of a component of the patient support apparatus and to generate an alert if the component changes out of the selected state.

According to yet another embodiment of the present disclosure, a patient support apparatus is provided that includes a litter frame, a support deck, a touchscreen, and a controller. The controller is configured to display a first screen including a first icon and a first help icon, a first explanation overlay including a second help icon and first information explaining the first icon, and a second explanation overlay including second information explaining the first icon. The controller is operable to display the first explanation overlay in response to selection of the first help icon and to display the second explanation overlay in response to selection of the second help icon.

According to some embodiments, the second explanation overlay includes a third help icon, and the controller is operable to display a third explanation overlay in response to selection of the second help icon.

In some embodiments, the first information comprises first text explaining the first icon, and the second information comprises second text, different from the first text, explaining the first icon.

At least one of the first explanation overlay or the second explanation overlay is partially transparent in some embodiments, such that the first screen is at least partially visible under the at least one of the first explanation overlay or the second explanation overlay while the controller is displaying the at least one of the first explanation overlay or the second explanation overlay.

In some embodiments, the first icon controls a component or a function of the patient support apparatus, and the controller is configured to disable the first icon if either the first explanation overlay or the second explanation overlay is displayed on the touchscreen.

According to still another embodiment of the present disclosure, a patient support apparatus is provided that includes a litter frame, a support deck, a touchscreen, and a controller. The controller is configured to display a settings screen, a first screen, a first explanation overlay, and a second explanation overlay. The settings screen includes input controls for selecting a user expertise level from at least a first user expertise level and a second user expertise level. The first screen includes a first icon and a help icon. The first explanation overlay includes first information explaining the first icon. The second explanation overlay includes second information, different that the first information, explaining the first icon. After selection of the first user expertise level, the controller displays the first explanation overlay in response to selection of the help icon and does not display the second explanation overlay. After selection of the second user expertise level, the controller displays the second explanation overlay in response to selection of the help icon and does not display the first explanation overlay.

According to some embodiments, the first and second explanation overlays are partially transparent such that the first screen is at least partially visible under the first or second explanation overlay while the controller is displaying the first or second explanation overlay.

In some embodiments, the controller is configured to disable the first screen if either the first explanation overlay or the second explanation overlay is displayed on the touchscreen.

In some embodiments, the first information comprises first text explaining the first icon and the second information comprises second text, different from the first text, explaining the first icon.

According to still another embodiment of the present disclosure, a patient support apparatus is provided that includes a litter frame, a support deck, an actuator adapted to move the litter frame or support deck, a sensor adapted to detect a position of the litter frame or support deck, a touchscreen, and a controller. The controller is configured to receive readings from the sensor and to generate a numeric indicator representative of the position of the litter frame or support deck based on the readings. The controller is operable to display a control screen on the touchscreen including a control icon for controlling the actuator, and is further configured to change a content of the control screen from a first content level to a second content level in response to the user pressing the control icon, where the first content level includes no display of the numeric indicator and the second content level includes a display of the numeric indicator. The controller is further configured to dynamically update the numeric indicator displayed at the second content level in response to the actuator moving the litter frame or support deck.

According to some embodiments, the controller is further configured to change the content of the control screen from the second content level back to the first content level in response to the user releasing the control icon or after a predefined time period of no user input at the control icon.

In some embodiments, the controller is further configured to change the content of the control screen from the first content level to the second content level by moving a portion of the control screen. The movement can be animated.

The control screen comprises, in some embodiments, multiple control icons and the second content level comprises multiple numeric indicators, wherein the controller is further configured to dynamically update the multiple numeric indicators displayed at the second content level in response to the user pressing one of the multiple control icons. Such dynamic updating may be continuous or intermittent.

Before the various embodiments disclosed herein are explained in detail, it is to be understood that the claims are not to be limited to the details of operation, to the details of construction, or to the arrangement of the components set forth in the following description or illustrated in the drawings. The embodiments described herein are capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a perspective view of a patient support apparatus according to one embodiment of the disclosure;

FIG. 2 is a diagram of a control system of the patient support apparatus of FIG. 1; and

FIG. 3 is a diagram of a user interface of the patient support apparatuses of FIGS. 1 and 2, the user interface having a touchscreen;

FIG. 4 is a diagram showing an illustrative menu screen that may be displayed on the touchscreen;

FIG. 5 is a diagram showing an illustrative position control screen that may be displayed on the touchscreen;

FIG. 6 is a diagram showing an illustrative numerical overlay that may be displayed on the position control screen of FIG. 5;

FIG. 7 is a diagram showing an illustrative scale screen that may be displayed on the touchscreen;

FIG. 8 is a diagram showing an illustrative screen that may be displayed on the touchscreen when the apparatus is incorrectly configured to weigh an occupant of the apparatus;

FIG. 9 is a diagram showing an illustrative lateral rotation therapy screen that may be displayed on the touchscreen;

FIG. 10 is a diagram showing an illustrative screen that may be displayed on the touchscreen when the apparatus is incorrectly configured to perform lateral rotation therapy;

FIG. 11 is a diagram showing an illustrative turn assist screen that may be displayed on the touchscreen;

FIG. 12 is a diagram showing an illustrative screen that may be displayed on the touchscreen when the apparatus is incorrectly configured to perform a turn assist;

FIG. 13 is a diagram similar to FIG. 3, showing an explanation overlay that may be displayed on the touchscreen.

FIG. 14 is a diagram similar to FIG. 3, showing another explanation overlay that may be displayed on the touchscreen.

FIG. 15 is a diagram showing an illustrative bed monitor screen that may be displayed on the touchscreen;

FIG. 16 is a diagram showing an illustrative explanation overlay that may be displayed on the bed monitor screen of FIG. 15;

FIG. 17 is a diagram showing another illustrative explanation overlay that may be displayed on the bed monitor screen of FIG. 15;

FIG. 18 is a diagram showing yet another illustrative explanation overlay that may be displayed on the bed monitor screen of FIG. 15;

FIG. 19 is a diagram showing an illustrative settings screen that may be displayed on the touchscreen; and

FIG. 20 is a diagram showing an illustrative help settings screen that may be displayed on the touchscreen.

### DETAILED DESCRIPTION OF THE EMBODIMENTS

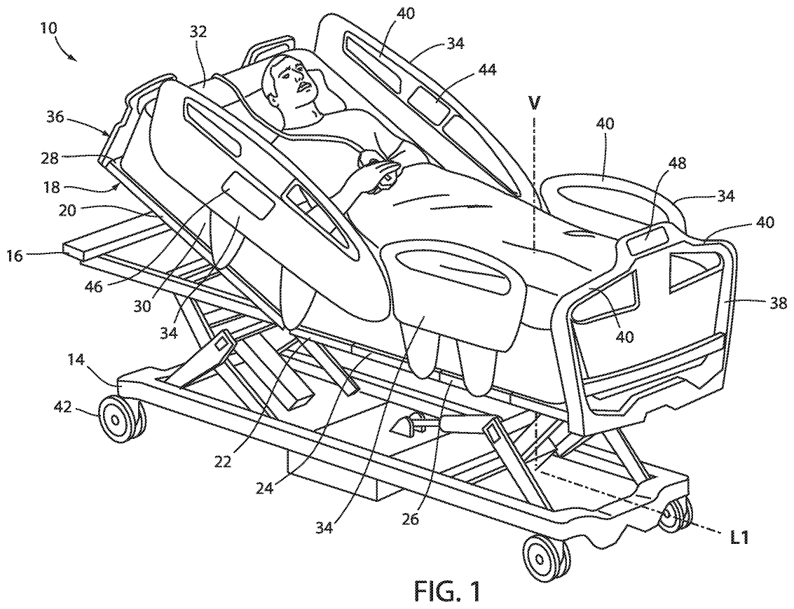

An illustrative patient support apparatus 10 that may incorporate one or more aspects of the present disclosure is shown in FIG. 1. Although the particular form of patient support apparatus 10 illustrated in FIG. 1 is a bed adapted for use in a hospital or other medical setting, it will be understood that patient support apparatus 10 could, in different embodiments, be a cot, a stretcher, a gurney, a recliner, or any other structure capable of supporting a patient that may be used during times when the patient is not accompanied by a caregiver. For purposes of the following written description, patient support apparatus 10 will be described as a bed with the understanding the following written description applies to these other types of patient support apparatuses.

In general, patient support apparatus 10 provides support for the patient and comprises a base 14 and a litter frame 16. The patient support apparatus 10 also comprises a support deck 18 supported on the litter frame 16. Support deck 18 is made of a plurality of sections, some of which are pivotable about generally horizontal pivot axes relative to the litter frame 16. In the embodiment shown in FIG. 1, support deck 18 includes a head section 20, a seat section 22, a thigh section 24, and a foot section 26. Head section 20, which is also sometimes referred to as a Fowler section, is pivotable about a generally horizontal pivot axis between a generally horizontal orientation (not shown in FIG. 1) and a plurality of raised positions (one of which is shown in FIG. 1). Thigh section 24 and foot section 26 may also be pivotable about generally horizontal pivot axes. The support deck 18 provides a mattress support surface 28 upon which the patient is supported.

The deck sections 20, 22, 24, 26 are pivotally coupled together by pivot pins, shafts, and the like at pivot joints (not shown) between adjacent deck sections. Additionally, other types of connections are possible between the deck sections 20, 22, 24, 26 so that the deck sections are capable of moving, e.g., articulating, relative to one another. For instance, in some cases, translational joints may be provided between adjacent deck sections, or other compound movement connections may be provided between adjacent deck sections, such as joints that allow both pivotal and translational motion between adjacent deck sections. Further, in other cases, the head section 20 and the thigh section 24 may be pivotally (or otherwise) connected directly to the litter frame 16 instead of the seat section 22.

A mattress 30 is disposed on the support deck 18 during use. The mattress 30 provides a patient support surface 32 upon which the patient is supported. The base 14, litter frame 16, support deck 18, and patient support surface 32 each have a head end and a foot end corresponding to a designated placement of the patient's head and feet on the patient support apparatus 10. The base 14 comprises a longitudinal axis L1 along its length from the head end to the foot end. The base 14 also comprises a vertical axis V arranged crosswise (e.g., perpendicularly) to the longitudinal axis L1 along which the litter frame 16 is lifted and lowered relative to the base 14.

Patient barriers, such as side rails 34 are coupled to the litter frame 16 and/or support deck 18 and are thereby supported by the base 14. Side rails 34 are all shown in a raised position in FIG. 1 but are each individually movable to a lower position in which ingress into, and egress out of, patient support apparatus 10 is not obstructed by the lowered side rails 34. In some embodiments, side rails 34 may be moved to one or more intermediate positions as well.

A headboard assembly 36 and a footboard 38 are coupled to the litter frame 16. Both the headboard assembly 36 and the footboard 38 are removably mounted on the litter frame 16. The headboard assembly 36 is coupled to the head section 20 in certain embodiments described further below, but in other embodiments may be coupled to the litter frame 16.

Handles 40 are provided on the side rails 34 and footboard 38 to facilitate movement of the patient support apparatus 10 over a floor surface, to move the side rails 34, and the like. Additional handles may be provided on other components of the patient support apparatus 10.

Wheels 42 are coupled to the base 14 to facilitate transport over a floor surface. The wheels 42 are arranged in each of four quadrants of the base 14 adjacent to corners of the base 14. In the embodiment shown, the wheels 42 are caster wheels able to rotate and swivel relative to the base 14 during transport. In some cases, the patient support apparatus 10 may not include any wheels.

Patient support apparatus 10 further includes a plurality of user interfaces 44, 46, 48 that enable a user of patient support apparatus 10, such as a patient and/or an associated caregiver, to control one or more aspects of patient support apparatus 10. In the embodiment shown in FIG. 1, patient support apparatus 10 includes a pair of inner side rail user interfaces 44 (only one of which is visible), a pair of outer side rail user interfaces 46 (only one of which is visible), and a footboard user interface 48. Footboard user interface 48 and outer side rail user interfaces 46 are intended to be used by caregivers, or other authorized personnel, while inner side rail user interfaces 44 are intended to be used by the patient associated with patient support apparatus 10. Not all of the user interfaces 44, 46, 48 include the same controls and/or functionality. In the illustrated embodiment, footboard user interface 48 includes a substantially complete set of controls for controlling patient support apparatus 10 while user interfaces 44 and 46 include a selected subset of those controls.

The mechanical construction of those aspects of patient support apparatus 10 not explicitly described herein may be the same as, or nearly the same as, the mechanical construction of the Model 3002 S3 bed manufactured and sold by Stryker Corporation of Kalamazoo, Mich. This mechanical construction is described in greater detail in the Stryker Maintenance Manual for the MedSurg Bed, Model 3002 S3, published in 2010 by Stryker Corporation of Kalamazoo, Mich., the complete disclosure of which is incorporated herein by reference. It will be understood by those skilled in the art that those aspects of patient support apparatus 10 not explicitly described herein can alternatively be designed with other types of mechanical constructions, such as, but not limited to, those described in commonly assigned, U.S. Pat. No. 7,690,059 issued to Lemire et al., and entitled HOSPITAL BED; and/or commonly assigned U.S. Pat. publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosures of both of which are also hereby incorporated herein by reference. The mechanical construction of those aspects of patient support apparatus 10 not explicitly described herein may also take on forms different from what is disclosed in the aforementioned references.

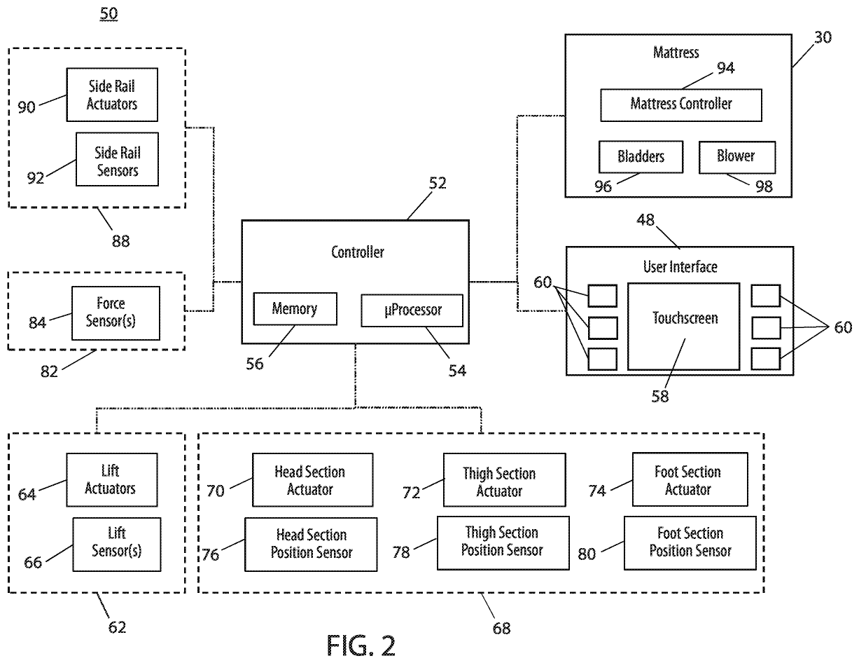

Referring additionally to FIG. 2, the patient support apparatus 10 includes a control system 50 provided to control operation of various components of the patient support apparatus 10. The control system 50 includes a controller 52 having one or more microprocessors 54 for processing instructions or for processing an algorithm stored in a memory 56 accessible to controller 52 to control operation of the various components.

Controller 52 is constructed of any electrical component, or group of electrical components, that are capable of carrying out the functions described herein. In many embodiments, controller 52 is a conventional microcontroller, although not all such embodiments need include a microcontroller. In general, controller 52 includes any one or more of microcontrollers, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. The instructions followed by controller 52 in carrying out the functions described herein, as well as the data necessary for carrying out these functions, are stored in memory 56.

Controller 52 is in communication with footboard user interface 48, as shown in FIG. 2. Controller 52 also communicates with the user interfaces 44 and 46 that are positioned on patient support apparatus 10, although these are not shown in FIG. 2 for purposes of clarity. Footboard user interface 48 includes a display 58 and a plurality of controls 60. Display 58 is a touchscreen in at least some embodiments, although it will be understood that a non-touch screen display may alternatively be used. The touchscreen 58 can be a multi-touch screen display capable of recognizing more than one point of contact. Controls 60 are shown in FIG. 2 as touch sensitive controls that may be physically implemented in a variety of different manners. In some embodiments, controls 60 are implemented as capacitive sensors positioned adjacent touchscreen 58 that capacitively detect when a user presses them. In other embodiments, controls 60 are implemented as buttons, switches, or other types of force or touch-sensitive device. In still other embodiments, one or more of controls 60 may be incorporated into touchscreen 58. Still other variations are possible.

The patient support apparatus 10 further comprises a lift system 62 that operates to lift and lower the litter frame 16, and thereby the support deck 18, relative to the base 14. The particular structural details of lift system 62 can vary widely. In the embodiment shown in FIG. 2, lift system 62 includes lift actuators 64 configured to move the litter frame 16 to any desired position, including tilting the litter frame 16 with respect to the base 14, and one or more lift sensor(s) 66 configured to the height and/or the angle of the litter frame 16. The lift actuators 64 can be operated independently, i.e. so that the head end and foot end of litter frame 16 can be independently adjusted, to place the litter frame 16 a flat position, a Trendelenburg position, or a reverse Trendelenburg position. Patient support apparatus 10 is designed so that when an occupant lies thereon, his or her head will be positioned adjacent the head end and his or her feet will be positioned adjacent the foot end. The lift actuators 64 may include hydraulic actuators, electric actuators, or any other suitable device for raising and lowering litter frame 16 with respect to base 14. Lift sensor(s) 66 may include any suitable sensor for detecting the height and/or angle of the litter frame 16 with respect to base 14. One exemplary lift system 62 is described in U.S. Patent Application Pub. No. 2017/0246065, filed on Feb. 22, 2017, entitled “Lift Assembly for Patient Support Apparatus,” which is hereby incorporated by reference herein in its entirety. Other types of lift systems can also be used, such as those described in U.S. Patent Application Publication No. 2016/0302985, filed on Apr. 20, 2016, entitled “Patient Support Lift Assembly,” which is hereby incorporated by reference herein in its entirety. The controller 52 processes instructions or an algorithm stored in memory to control operation of the lift actuator(s) 64 and coordinate movement of the lift actuator(s) 64 to move the litter frame 16, including lifting, lowering, or tilting the litter frame 16.

The patient support apparatus 10 further comprises an articulation system 68 that articulates the deck sections 20, 24, and 26 of the support deck 18. The particular structural details of articulation system 68 can vary widely. In the embodiment shown in FIG. 2, articulation system 68 includes at least one head section actuator 70, at least one thigh section actuator 72, and at least one foot section actuator 74 capable of moving, i.e. pivoting or articulating, the head section 20, thigh section 24, and foot section 26, respectively, relative to one other and relative to the seat section 22, which is stationary or fixed in the current embodiment. The deck section actuators 70, 72, 74 may be linear actuators, rotary actuators, or other type of actuators capable of moving the head section 20, thigh section 24, and foot section 26. The deck section actuators 70, 72, 74 may be electrically powered, hydraulic, electro-hydraulic, pneumatic, or the like. The articulation system 68 further includes one or more position sensor(s) 76, 78, 80 configured to detect a configuration of the support deck 18, including the position or angle of each of the head section 20, thigh section 24, and foot section 26. Position sensor(s) 76, 78, 80 may include tilt sensors or potentiometers for sensing an angular position of the associated deck section 20, 24, 26, or any other suitable sensor for detecting the position or angle of the deck sections 20, 24, 26. One exemplary articulation system 68 is described in U.S. Pat. No. 7,472,439, filed on Feb. 23, 2006, entitled “Hospital Patient Support,” which is hereby incorporated by reference herein in its entirety. The controller 52 processes instructions or an algorithm stored in memory to control operation of the deck section actuators 70, 72, 74 and coordinate movement of the deck section actuators 70, 72, 74 to move one or more of the deck sections.

The patient support apparatus 10 further comprises a scale system 82 that that is adapted to weigh an occupant, such as, but not limited to, a patient, of patient support apparatus 10. The particular structural details of scale system 82 can vary widely. In the embodiment shown in FIG. 2, scale system 82 includes one or more force sensor(s) 84 such as, but not limited to, load cells, linear variable displacement transducers and/or any one or more capacitive, inductive, and/or resistive transducers that are configured to produce a changing output in response to changes in the force exerted against them. Still other types of forces sensors may be used with patient support apparatus 10. Force sensor(s) 84 are configured to detect the weight of any objects or persons who are wholly or partially being supported by support deck 18. The outputs of force sensor(s) 84 are processed by controller 52 and selectively displayed as a patient weight by the touchscreen 58 a discussed in greater detail below. One exemplary scale system 82 is described in U.S. Patent Application Pub. No. 2017/0003159, filed on Jun. 17, 2016, entitled “Person Support Apparatus with Load Cells,” which is hereby incorporated by reference herein in its entirety.

The patient support apparatus 10 further comprises a side rail system 88 that operates to lift and lower the side rails 34 relative to the litter frame 16 and/or support deck 18. The particular structural details of side rail system 88 can vary widely. In the embodiment shown in FIG. 2, side rail system 88 includes side rail actuators 90 and side rail position sensor(s) 92 for each side rail. Side rail actuators 90 are configured to move one of the side rails 34 to at least a raised position shown in FIG. 1 and a lower position (not shown), and optionally one or more intermediate positions as well. The side rail actuators 90 may include hydraulic actuators, electric actuators, or any other suitable device for raising and lowering individual side rails 34. Side rail position sensor(s) 92 are configured to detect the current position of the side rails 34. The outputs of side rail position sensor(s) 92 are processed by controller 52 and selectively displayed as a side rail positon by the touchscreen 58 a discussed in greater detail below. The controller 52 processes instructions or an algorithm stored in memory to control operation of the side rail actuators 90 and coordinate movement of the actuators 90 to move one or more of the side rails 34.

The mattress 30 includes a mattress controller 94 used in controlling one or more functions of the mattress. Mattress functions include at least lateral rotation therapy and turn assist. Optionally, additional mattress functions include one or more of the following: an alternating pressure therapy, a percussion therapy, a vibration therapy, and a low airloss therapy. The particular structural details of mattress 30 can vary widely. In the embodiment shown in FIG. 2, mattress 30 includes a pneumatic system having one or more bladders 96 and at least one blower 98 for inflating and deflating one or more of the bladders 96. One exemplary mattress 30 that may be used with the patient support apparatus 10 is described in U.S. Patent Application Pub. No. 2014/0059780, filed on Sep. 5, 2013, entitled “Patient Support,” which is hereby incorporated by reference herein in its entirety. In lateral rotation therapy, sometimes referred to as continuous lateral rotation therapy or simply rotation therapy, a patient supported on the mattress 30 is rotated side to side in an effort to reduce pulmonary complications of immobility. For turn assist, a patient supported on the mattress 30 is turned or rotated laterally to one side for a period of time to help reposition the patient, such as to prevent bed sores.

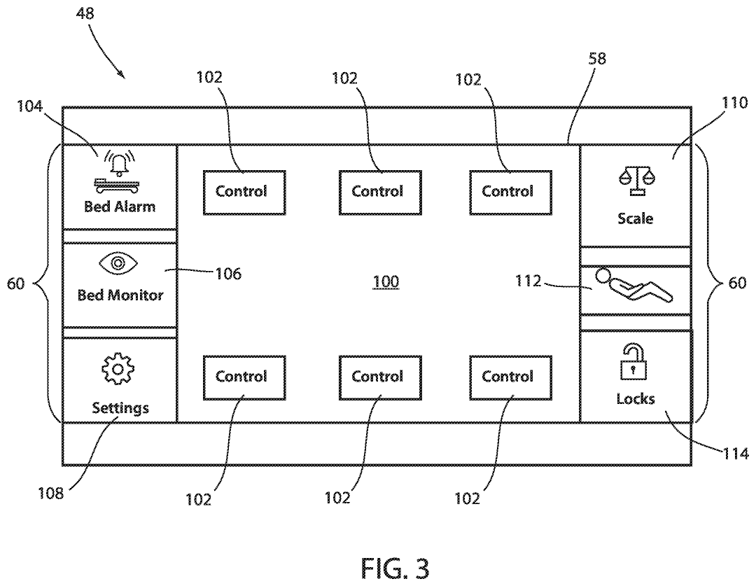

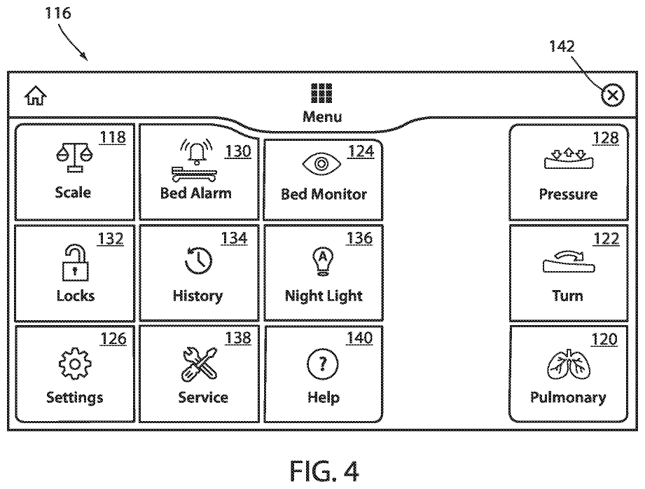

FIG. 3 illustrates in more detail one manner in which user interface 48 (or another user interface 44 or 46 on patient support apparatus 10) is implemented. User interface 48 includes a screen 100 displayed on the touchscreen 58 having a plurality of touchscreen controls 102, and a plurality of non-touchscreen controls 60 that are positioned adjacent to touchscreen 58. The touchscreen controls 102 may perform a variety of different functions, and the number, function, lay-out, size, and/or other characteristics of these controls may vary from what is shown in FIG. 3, and may also vary depending upon what screen 100 is being displayed at a given time by touchscreen 58. Some non-limiting examples of screens 100 and touchscreen controls 102 are provided in the FIGS. 4-20.

In the particular example of FIG. 3, the non-touchscreen controls 60 include a bed alarm control 104, a bed monitor control 106, a settings control 108, a scale control 110, a position control 112, and a locks control 114, although it will be understood that in different embodiments, any of these controls could be implemented as a touchscreen control 102. The bed alarm control 104 is used to activate and deactivate an exit detection system of the patient support apparatus 10. One exemplary exit detection system is described in U.S. Pat. No. 5,276,432, filed on Jan. 15, 1992, entitled “Patient Exit Detection Mechanism for Hospital Bed,” which is hereby incorporated by reference herein in its entirety. The bed monitor control 106 is used to control a bed monitor system of the patient support apparatus 10, such as to activate and deactivate the bed monitor system or change one or more settings of the bed monitor system, as explained in further detail below. One exemplary bed monitor system that may be incorporated into the patient support apparatus 10 is described in U.S. Pat. No. 8,844,076, filed on Jan. 27, 2014, entitled “Patient Handling Device Including Local Status Indication, One-Touch Fowler Angle Adjustment, and Power-On Alarm Configuration,” which is hereby incorporated by reference herein in its entirety. The settings control 108 is used to change one or more settings of the patient support apparatus 10, as described in further detail below. The scale control 110 is used to take a weight reading of an occupant of the patient support apparatus 10 using the scale system 82, as described in further detail below. The position control 112 is used to change a configuration or position of the patient support apparatus 10, such as changing the height or angle of the litter frame 16 using the lift system 62 or the configuration of the support deck 18 using the articulation system 68, as described in further detail below. The locks control 114 is used to prevent the configuration or position of the patient support apparatus 10 from being changed at one of the other user interfaces 44 or 46. That is, control of the lift system 62 and the articulation system 68 can be locked out from the other user interfaces 44 or 46. User selection of any one of these controls 104-114 displays a different screen 100, particular to the associated control, on the touchscreen 58.

FIG. 4 illustrates a menu screen 116 displayed on the touchscreen 58. Menu screen 116 may be displayed initially after the patient support apparatus 10 is powered on, or it may be displayed in response to a user navigating to it from another screen. It will be understood that the particular layout shown in FIG. 4 is only one of a large variety of different ways in which controller 52 may present a main menu screen. As can be seen in FIG. 4, menu screen 116 includes a plurality of touchscreen controls, including at least a scale control 118, a lateral rotation control 120, a turn assist control 122, a bed monitor control 124, and a settings control 126. User selection of any one of these controls 118-126 displays a different screen, particular to the associated control, on the touchscreen 58, examples of which are given below. Additional touchscreen controls include a pressure control 128, a bed alarm control 130, a locks control 132, a history control 134, a night light control 136, a service control 138, and a help control 140. User selection of any one of these controls 118-126 displays a different screen, particular to the associated control, on the touchscreen 58. Examples of screens for controls 118-126 are not provided herein as they are not necessary for understanding the inventive concepts disclosed herein. Briefly, the bed alarm control 130 and locks control 132 are touchscreen duplicates of the non-touchscreen controls 104 and 114 described above with reference to FIG. 3. The pressure control 128 displays a pressure redistribution screen (not shown) which includes control inputs for operating the mattress 30 in a pressure redistribution mode. The history control 134 displays a history screen (not shown) which includes historical information on the operation or maintenance of the patient support apparatus 10. The night light control 136 displays a night light screen (not shown) which includes control inputs for a night light of the patient support apparatus 10. The service control 138 displays a service screen (not shown) which includes information on service topics such as how to perform or request maintenance on the patient support apparatus 10. The help control 140 displays a help screen (not shown) which includes information on help topics such as the use, operation, and functions of the patient support apparatus 10. A cancel control 142 allows the user to return to a home screen or the previously displayed screen.

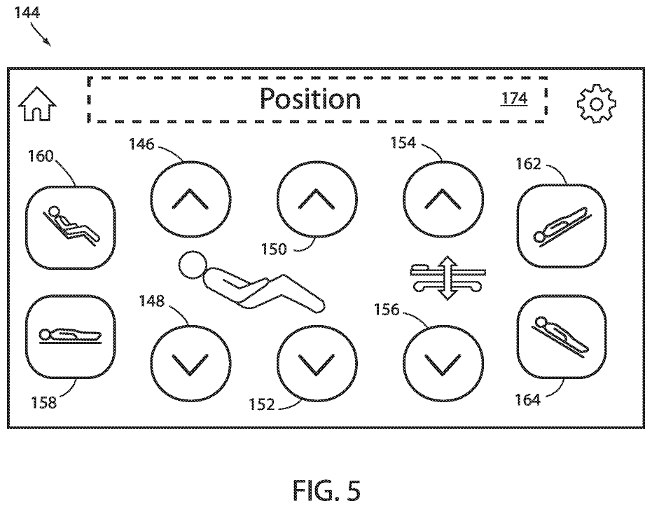

When the position control 112 on the user interface 48 of FIG. 3 is selected, the controller 52 displays position control screen 144, shown in FIG. 5, on touchscreen 58. The display of screen 144 may occur immediately after the position control 112 is pressed, or there may be one or more intermediate controls/screens that need to be followed before getting to screen 144. However arrived at, the display of screen 144 includes at least one control icon for controlling the position of at least one component of the patient support apparatus 10, such as one or more of the litter frame 16 or the support deck 18. As shown herein, the display screen 144 includes a control icon 146 for raising the head section 20 of the support deck 18, a control icon 148 for lowering the head section 20 of the support deck 18, a control icon 150 for raising the foot section 26 of the support deck 18, a control icon 152 for lowering the foot section 26 of the support deck 18, a control icon 154 for raising the litter frame 16, a control icon 156 for lowering the litter frame 16, a one-touch control icon 158 for moving the support deck 18 to a flat position, a one-touch control icon 160 for moving the support deck to a Fowler's position, a one-touch control icon 162 for moving the support deck 18 to a Trendelenburg position, and a one-touch control icon 164 for moving the support deck 18 to a reverse Trendelenburg position. While not shown, individual controls for raising and lowering the thigh section 24 of the support deck 18 can be provided on screen 144, as well as controls for raising the lowering the side rails 34.

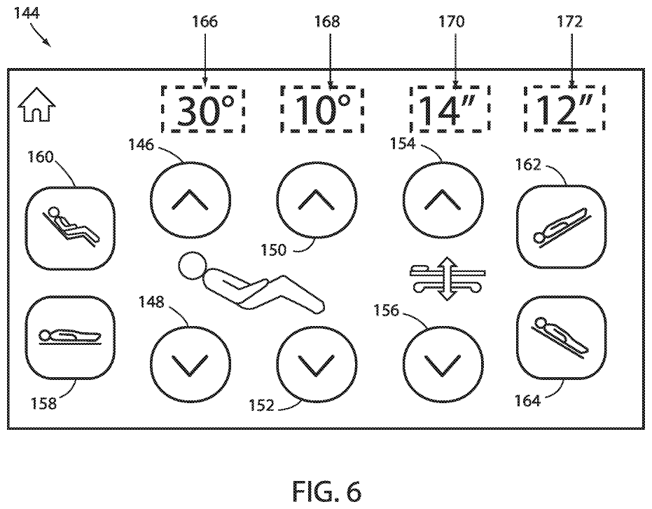

When first displayed, the screen 144 has a first content level as shown in FIG. 5. The controller 52 is configured to change a content of the screen 144 from the first content level to a second content level, shown in FIG. 6, in response to a user pressing one of the control icons 146-164. When a user releases the control icons 146-164, controller 52 changes the content level from the second content level of FIG. 6 back to the first content level of FIG. 5. This change occurs instantaneously upon the user's release of the control icon 146-164 in some embodiments. In other embodiments, this change occurs after a predetermined time period has lapsed since the user released the control icon 146-164, such as, but not limited to, after about three to five seconds.

The second content level includes at least one numeric indicator 166, 168, 170, and/or 172 (FIG. 6). Outputs from the position sensor(s) 66, 76, 78, 80 (FIG. 2) are processed by controller 52 to generate the numeric indicators 166-172 representative of the positions of the litter frame 16 or support deck 18. Specifically, numeric indicator 166 indicates the angle of the head section 20, numeric indicator 168 indicates the angle of the foot section 26, numeric indicator 170 indicates the height of the litter frame 16, and numeric indicator 172 the angle of the littler frame 16.

When user input to control the litter frame 16 or support deck 18 is received at screen 144, the controller 52 is configured to display the numeric indicators 166-172, as shown in FIG. 6. The first content level (FIG. 5) includes no display of the numeric indicators 166-172 and the second content level (FIG. 6) includes a display of the numeric indicators 166-172. This may entail alternating or changing the content of the screen 144 to make room for the numeric indicators 166-172 while keeping the same control icons 146-164 on the screen 144, as the numeric indicators 166-172 are not displayed prior to receiving user input at screen 144. This saves space on the touchscreen 58 by not showing positional information until it is needed by the user. Also, by using an overlay where the input controls 146-164 are still accessible, the user is not dissociated from their current task by the display of numeric indicators 166-172.

The controller 52 is further configured to dynamically update one or more of the numeric indicators 166-172 displayed at the second content level in response to one or more of the actuators 64, 70, 72, 74 (FIG. 2) moving the litter frame 16 or one of the deck sections 20, 24, 26 of the support deck 18. For example, if the user presses either input control 146, 148 for raising or lowering the head section 20, controller 52 increases or decreases the corresponding numeric indicator 166 displayed on screen 144 in accordance with the received outputs from the head section position sensor 76. Likewise, if the user presses either input control 150, 152 for raising or lowering the foot section 26, controller 52 increases or decreases the corresponding numeric indicator 168 displayed on screen 144 in accordance with the received outputs from foot section sensor 80. And if user presses the either input control 154, 156 for raising or lowering the litter frame 16, controller 52 increases or decrease the corresponding numeric indicator 170 displayed on screen 144 in accordance with the received outputs from lift sensors 66. If the user presses any of the one-touch input controls 158-164 for moving the support deck 18 to a predefined position, controller 52 dynamically updates multiple numeric indicators 166-172 on the screen 144 so that the indicators 166-172 have values that match the current position/angle of the various components of the patient support apparatus 10. The user can also press multiple controls at once and the corresponding ones of indicators 166-172 will be dynamically updated by controller 52.

Only those individual indicators 166-172 corresponding to actuators that have changed position are updated by controller 52. Thus, in some situations, only a single indicator 166 is updated (e.g. only indicator 166 is updated if only control 146 (or only control 148) is pressed). In other situations, such as pressing control 162, multiple actuators are simultaneously activated and multiple indicators 166-172 are updated at the same time by controller 52. Regardless of whether one indicator 166-172 is being individually updated, or multiple indicators 166-172 are being simultaneously updated, in the typical, the updating of the indicators 166-172 occurs substantially in real time—that is, substantially simultaneously with the movement of the actuator(s). In other embodiments, there may be a delay between an actuator reaching a particular position and the indicator 166 being updated to reflect the new position.

The change between the first content level and the second content level can include replacing or overlaying a portion of the screen 144 with different content or moving a portion of the screen 144 to accommodate different content. Such movement can be smoothly animated. In one example, the animation includes a title header 174 on the screen 144 that is displayed as sliding smoothly upwardly to reveal the numeric indicators 166-172. In another example, the animation includes the numeric indicators 166-172 being displayed to smoothly slide downwardly over the title header 174. In other examples, the movement may not be animated, but instead may simply show a discontinuous jump between an initial position and a final position (e.g. title header 174 is initially displayed in a lower position and then switched to being displayed in an upward location such that, in the new position, there is space for numeric indicators 166-172). In still other embodiments, one or more items on the display 58 may fade out in order to provide space for the numeric indicators 166-172 and fade in after the actuator movement has stopped.

The controller 52 changes the content of the screen 144 back to the first content level (FIG. 5) in response to the user releasing the control icon 146-164. This change can happen immediately, or can happen after a predefined time period of no user input at the control icons 146-164. The change back to the first content level includes replacing or overlaying a portion of the screen 144 with different content or moving a portion of the screen 144 to accommodate different content. Such movement can be animated. In one example, the animation includes the numeric indicators 166-172 sliding upwardly to reveal title header 174. In another example, the animation includes the title header 174 sliding downwardly over the numeric indicators 166-172.

The title header 174 is but one example of a portion of the screen 144 that is changed to display the second content level. In other examples, the screen 144 includes other text or graphics which are replaced, overlaid, resized, or moved in order to display the second content level on the screen 144.

The controller 52 can be configured to provide additional visual feedback to the user via screen 144, such as changing a color of the numeric indicators 166-172 when a minimum or maximum setting has been reached. Similarly, the numeric indicators 166-172 or the control icons 146-164 can be displayed in different colors when any of these control icons 146-164 are locked out (i.e. when changes to the position of the litter frame 16 or the deck sections 20, 24, 26 are not permitted). Still further, in some embodiments, controller 52 is configured to display the controls 146, 148, 150, 152, 154, 156, 158, 160, 162, and 164 in a first color when they are not pressed, to switch to displaying whichever one (or ones) of them are pressed in a second and different color, and to switch to displaying whichever one (or ones) of them are pressed in a third color when their corresponding actuator has reached a maximum position. Thus, for example, Fowler up button 146 is displayed in a first color when it is not pressed. When a user presses it, controller 52 switches to displaying it in a second color. If the user continues to press it until the Fowler section reaches its maximum height, controller 52 will switch to displaying control 146 in a third color. Controller 52 will further switch back to displaying the control 146 in the first color after a user has stopped pressing it (or after a predetermined amount of time has passed after the cessation of pressing).

Still further, in some embodiments, controller 52 is configured to stop displaying any of controls 146-164 wherein the corresponding actuator has reached its maximum limit. For example, if the Fowler down control 148 is pressed (and controller 52 switches to displaying it in the second color), controller 52 will stop displaying control 148 after the Fowler has reached its lowermost limit (or alternatively it will display it in a third color until the user removes his or her finger from control 148, at which point controller 52 then ceases to display control 148). Thereafter, if the user presses Fowler up control 146 and raises the Fowler up again at least slightly, controller 52 resumes displaying down control 148 (because the Fowler section is thereafter capable of being moved down). In this manner, whenever an actuator has reached its limit and cannot be moved further in a certain direction, controller 52 removes the corresponding control 146-164 from the display that would otherwise cause the actuator to move further in the direction whose limit has been reached. As an alternative to completely removing the control 146-164 from the display, controller 52 can be configured to change the color (e.g. greying it out), size, shape, content, or other aspect of the control in order to indicate to the user that the actuator has reached its limit.

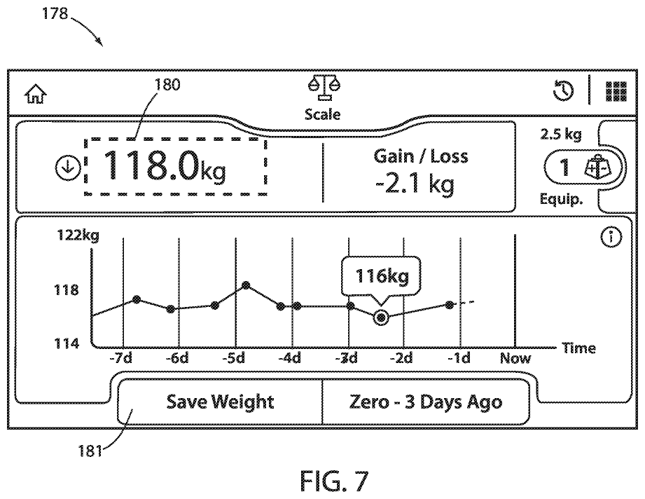

Turning to the scale feature, when the scale control 110 on the user interface 48 of FIG. 3 is selected or when the scale control 118 on the menu screen 116 of FIG. 4 is selected, the controller 52 displays scale screen 178, shown in FIG. 7, on touchscreen 58. The display of scale screen 178 may occur immediately after the scale control 110 or 118 is pressed, or there may be one or more intermediate controls/screens that need to be followed before getting to scale screen 178. However arrived at, the display of scale screen 178 includes an indicator 180 of the patient's weight, as determined by the scale system 82, i.e. the force sensors 84, and a save weight icon 181 used to store the patient's weight reading.

Upon selection of the scale control 110 or 118, the controller 52 determines whether the patient support apparatus 10 is properly positioned to take a weight reading. That is, some jurisdictions (e.g. Europe) have regulations in effect that dictate that medical weight readings are taken of a load while the load is supported on a level surface (see, e.g. the Non-Automatic Weighing Instruments (NAWI) Directive of the European Parliament (2014/31/EU)). If the surface is not level, the weight reading is not acceptable as a valid weight reading. Accordingly, patient support apparatus 10 is configured to detect whether the litter frame 16 is level or not prior to taking a weight reading. That is, readings from position sensors 76, 78, and 80 are fed to the controller 52 to determine whether the patient support apparatus 10 is properly positioned to take a weight reading, i.e. that the litter frame 16 is level.

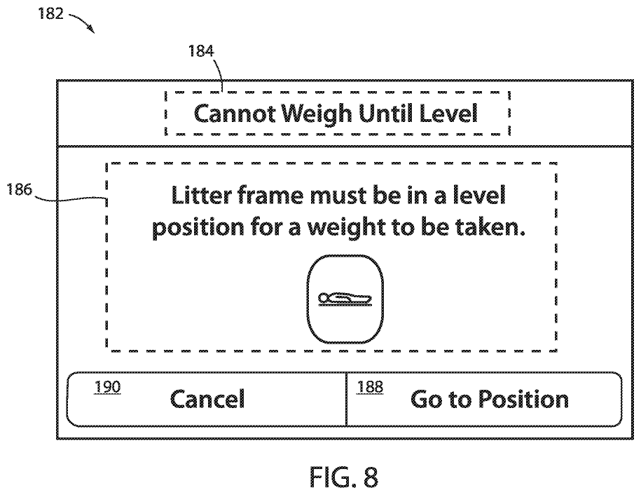

If the controller 52 determines that the patient support apparatus 10 is properly positioned to take a weight reading, controller 52 enables the save weight icon 181 on scale screen 178. If the controller 52 determines that the patient support apparatus 10 is not properly positioned to take a weight reading, i.e. that the litter frame 16 is not level, the save weight icon 181 is disabled, thereby preventing the user from storing the patient's weight reading, and screen 182 is displayed, as shown in FIG. 8. The screen 182 can be a pop-up window displayed over a portion of the scale screen 178, such that the scale screen 178 is still partially visible behind the pop-up window, or screen 182 may replace the scale screen 178 entirely.

Alternatively, instead of displaying scale screen 178 first when the scale control 110 or 118 is selected, the controller 52 can first determine whether the patient support apparatus 10 is properly positioned to save a weight reading prior to showing the scale screen 178. If the controller 52 determines that the patient support apparatus 10 is not properly positioned to save a weight reading, screen 182 is immediately displayed over a portion of the scale screen 178 or instead of the scale screen 178, such that the full turn scale screen 178 is not completely visible until the litter frame 16 is level.

Screen 182 includes an error message 184 notifying the user of the error, i.e. that the apparatus 10 is in an unacceptable state for taking a weight reading, and an indicator 186 of the acceptable state, including text and/or graphics describing the acceptable state. Here, the indicator 186 lets the user know that the litter frame 16 must be in a level position to take a weight reading. Screen 182 also includes a control icon 188 that allows the user to move the litter frame 16 to the level position. This bypasses the need for the user to navigate to the position controls for the litter frame 16, such as are found in screen 144 of FIG. 6, and then back to the scale controls. The control icon 188 comprises a one-touch input control for moving the litter frame 16 to a level configuration acceptable for taking a weight reading. After pressing the control icon 188, the controller 52 is configured to activate the lift actuators 64 to move the apparatus 10 from its current configuration to the acceptable state for taking a weight reading, and the controller 52 displays scale screen 178, shown in FIG. 7, on touchscreen 58.

Screen 182 also includes a cancel icon 190 that allows the user to return to the scale screen 178 (FIG. 7) without changing the state of the apparatus 10. Alternatively, instead of or in addition to the cancel icon 190, controller 52 can be configured to stop displaying screen 182 in response to a user touching the touchscreen 58 anywhere outside the boundaries of the screen 182 in those embodiments where the screen 182 is smaller than the display area of the touchscreen 58.

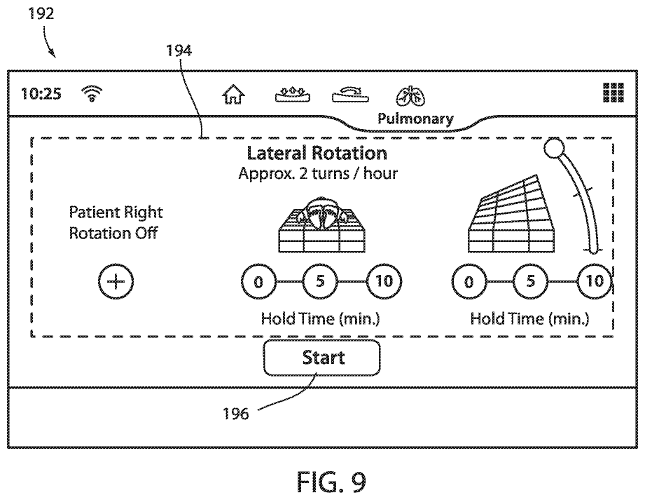

Turning to the lateral rotation therapy feature, when the lateral rotation control 120 on the menu screen 116 of FIG. 4 is selected, the controller 52 displays therapy screen 192, shown in FIG. 9, on touchscreen 58. The display of therapy screen 192 may occur immediately after the lateral rotation control 120 is pressed, or there may be one or more intermediate controls/screens that need to be followed before getting to therapy screen 192. However arrived at, the display of therapy screen 192 includes one or more controls 194 for inputting a desired therapy program, including whether the patient is rotated both left and right, the number of turns per hour, and the hold time per rotation. A start control 196 is provided on therapy screen 192 for initiating lateral rotation therapy once a desired therapy program is set.

Upon selection of the start control 196, the controller 52 determines whether the patient support apparatus 10 is properly positioned to perform lateral rotation therapy prior to beginning the therapy program. Acceptable states for lateral rotation therapy can include: the height of the litter frame 16 being within a predefined range or at a predefined value; the angle of the litter frame 16 being within a predefined range or at a predefined value; the angle of the head section 20 being within a predefined range or at a predefined value; the angle of the thigh section 24 being within a predefined range or at a predefined value; the angle of the foot section 26 being within a predefined range or at a predefined value; and/or one or more of the side rails 34 being in a predefined position (i.e. raised). For the embodiment discussed herein, the head section 20 of the support deck 18 must be within a predefined range of angles in order to perform lateral rotation therapy, although it is understood that the configuration of other components of the patient support apparatus 10 may also have acceptable and unacceptable states for lateral rotation therapy. In one example, the predefined range is more than 0 but less than 60 degrees with respect to either horizontal or with respect to a plane defined generally by litter frame 16. Readings from the head section position sensor 76 are used as input by the controller 52 to determine whether the patient support apparatus 10 is properly positioned to perform lateral rotation therapy.

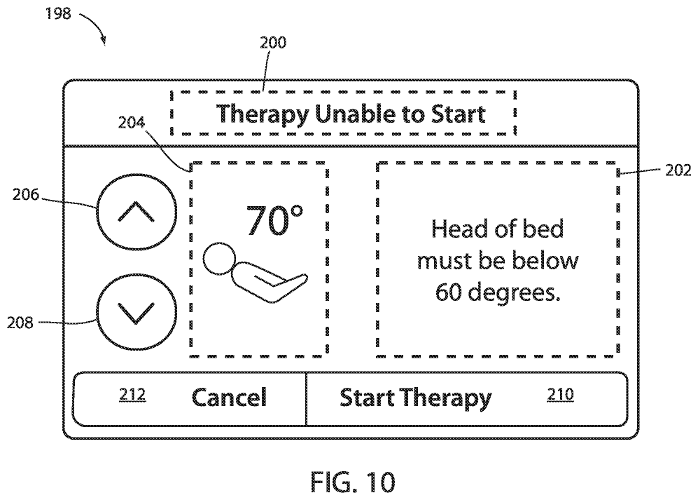

If the controller 52 determines that the patient support apparatus 10 is properly positioned to perform lateral rotation therapy, the therapy program begins when the user presses the start icon 196. If the controller 52 determines that the patient support apparatus 10 is not properly positioned to perform lateral rotation therapy, i.e. that head section 20 is <0 or 60 degrees, screen 198 is displayed, as shown in FIG. 10, in response to the user pressing the start icon 196. When displaying screen 198, the controller 52 prevents lateral rotation therapy from starting until the patient support apparatus 10 is moved to an acceptable state. The screen 198 can be a pop-up window displayed over a portion of the therapy screen 192, such that the therapy screen 192 is still partially visible behind the pop-up window, or may replace the therapy screen 192 entirely.

Alternatively, instead of displaying therapy screen 192 first when the lateral rotation control 120 on the menu screen 116 of FIG. 4 is selected, the controller 52 can first determine whether the patient support apparatus 10 is properly positioned to perform lateral rotation therapy prior to showing the therapy screen 192. If the controller 52 determines that the patient support apparatus 10 is not properly positioned to perform lateral rotation therapy, screen 198 is immediately displayed over a portion of the therapy screen 192 or instead of the therapy screen 192, such that the full therapy screen 192 is not completely visible until the patient support apparatus 10 is properly positioned.

Screen 198 includes an error message 200 notifying the user of the error, i.e. that the apparatus 10 is in an unacceptable state for lateral rotation therapy, and an indicator 202 of the acceptable state, including text and/or graphics describing the acceptable state. Here, the indicator 202 lets the user know that the head section must be below 60 degrees for lateral rotation therapy. Controller 52 changes the indicator 202 displayed according to the current angle of the head section 20. For example, if the apparatus 10 is currently in a Trendelenburg position, the indicator 202 lets the user know that the head section must be above 0 degrees for lateral rotation therapy. Screen 198 also includes an indicator 204 of the current state of the patient support apparatus 10, including text and/or graphics describing the current state. Here, the indicator 204 includes a graphic representing the head section 20 and the current angle of the head section 20.

Screen 198 also includes at least one control icon 206, 208 that allows the user to move the head section 20 to the acceptable state. Control icon 206 is an input control for raising the head section 20 and control icon 208 is an input control for lowering the head section 20. This bypasses the need for the user to navigate to the position controls for the head section 20, such as are found in screen 144 of FIG. 6, and then back to the lateral rotation controls of screen 192.

After pressing either control icon 206, 208, the controller 52 is configured to activate the head section actuator 70 to move the head section 20 according to the user input. The indicator 204 of the current state of the head section 20 dynamically updates as the head section 20 is moved, so that the head angle displayed in indicator 204 matches the current angle of head section 20.

A start control 210 is provided on screen 198 for initiating lateral rotation therapy once the head section 20 reaches the acceptable state. The start control 210 is disabled by the controller 52 until the head section 20 is in the acceptable state. If the start control 210 is pressed prior to the head section 20 being in the acceptable state, the controller 52 may provide an additional notification to the user, such as a color change or a light flash at screen 198, or an audible alert via a speaker on the user interface 48. Alternatively, the start control 210 is not enabled until the head section 20 is in an acceptable state or the start control 210 is simply not provided at screen 198. In the latter case, the controller 52 automatically returns to therapy screen 192 once the head section 20 reaches the acceptable state, and the user can select the start control 196 from therapy screen 192. Screen 198 also includes a cancel icon 212 that allows the user to return to the therapy screen 192 (FIG. 9) or the menu screen 116 (FIG. 4) without changing the angle of the head section 20. Alternatively, instead of or in addition to the cancel icon 212, touch input anywhere outside of the boundaries of screen 198 on the touchscreen 58 removes screen 198 in embodiments where screen 198 is smaller than the display area of the touchscreen 58.

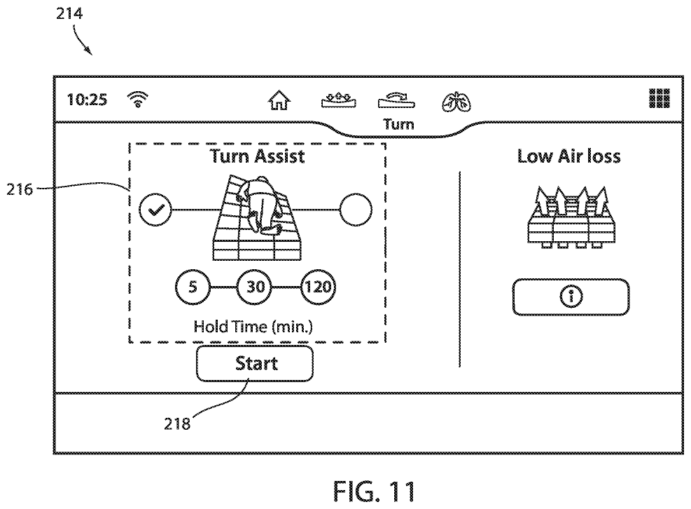

Turning to the turn assist feature, when the turn assist control 122 on the menu screen 116 of FIG. 4 is selected, the controller 52 displays turn assist screen 214, shown in FIG. 11, on touchscreen 58. The display of turn assist screen 214 may occur immediately after the turn assist control 122 is pressed, or there may be one or more intermediate controls/screens that need to be followed before getting to turn assist screen 214. However arrived at, the display of turn assist screen 214 includes one or more controls 216 for inputting a desired turn, including whether the patient is turned left or right, and the hold time per turn. A start control 218 is provided on turn assist screen 214 for initiating a turn once a desired turn program is set.

Upon selection of the start control 218, the controller 52 determines whether the patient support apparatus 10 is properly positioned to perform a turn to beginning the turn. Acceptable states for turn assist can include: the height of the litter frame 16 being within a predefined range or at a predefined value; the angle of the litter frame 16 being within a predefined range or at a predefined value; the angle of the head section 20 being within a predefined range or at a predefined value; the angle of the thigh section 24 being within a predefined range or at a predefined value; the angle of the foot section 26 being within a predefined range or at a predefined value; and/or one or more of the side rails 34 being in a predefined position (i.e. raised). For the embodiment discussed herein, side rails 34 must be raised in order to perform a turn, although it is understood that the configuration of other components of the patient support apparatus 10 may also have acceptable and unacceptable states for performing a turn. Readings from the side rail sensors 92 are used as input by the controller 52 to determine whether the patient support apparatus 10 is properly positioned to perform a turn.

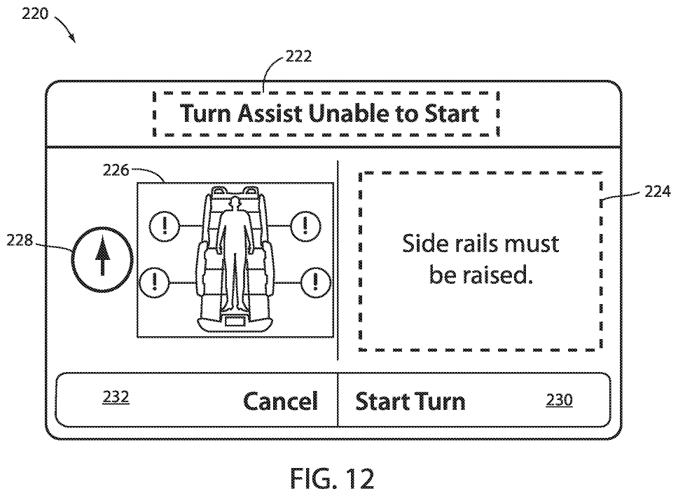

If the controller 52 determines that the patient support apparatus 10 is properly positioned to perform a turn, the turn begins in response to the user selecting start control 218. If the controller 52 determines that the patient support apparatus 10 is not properly positioned to perform a turn, i.e. that one or more of the side rails is lowered, screen 220 is displayed, as shown in FIG. 12, in response to the user selecting start control 218. The controller 52 prevents start control 218 from starting the turning function until the patient support apparatus 10 is in an acceptable state. Screen 220 can be a pop-up window displayed over a portion of the turn assist screen 214, such that the turn assist screen 214 is still partially visible behind the pop-up window, or it may replace the turn assist screen 214 entirely.

Alternatively, instead of displaying turn assist screen 214 first when the turn assist control 122 on the menu screen 116 of FIG. 4 is selected, the controller 52 can first determine whether the patient support apparatus 10 is properly positioned to perform a turn prior to showing the turn assist screen 214. If the controller 52 determines that the patient support apparatus 10 is not properly positioned to perform a turn, screen 220 is immediately displayed over a portion of the turn assist screen 214 or instead of the turn assist screen 214, such that the full turn assist screen 214 is not completely visible until the side rails 34 are raised.

Screen 220 includes an error message 222 notifying the user of the error, i.e. that the apparatus 10 is in an unacceptable state for a turn, and an indicator 224 of the acceptable state, including text and/or graphics describing the acceptable state. Here, the indicator 224 lets the user know that the side rails 34 must be raised for turn assist. The controller 52 changes the indicator 224 displayed according to the current state of the patient support apparatus 10. For example, if one particular side rail 34 is lowered, the indicator 224 lets the user know which side rail must be raised. Screen 220 also includes an indicator 226 of the current state of the patient support apparatus 10, including text and/or graphics describing the current state. Here, the indicator 226 includes a graphic representing the patient support apparatus 10 with side rails 34, and the current position of each side rail 34.

Screen 220 also includes at least one control icon 228 that allows the user to move the side rails 34 to the acceptable state. Control icon 228 is an input control for raising the side rails 34 by activating one or more of the side rail actuators 90. This bypasses the need for the user to navigate to the position controls for the side rails 34, and then back to the turn assist controls. In some embodiments of the patient support apparatus 10, side rail actuators 90 are not included so that the position of the side rails 34 must be changed manually. In such embodiments, control icon 228 is omitted.

After pressing the control icon 228, the controller 52 is configured to activate the necessary side rail actuators 90 as needed to move the side rails to the acceptable state for making an assisted turn. The indicator 226 of the current state of the side rails dynamically updates as one or more of the side rails 34 are raised, such as by changing a color of the side rail. A start control 230 is provided on screen 220 for initiating the turn once the side rails 34 reach the acceptable state. The start control 230 is disabled by the controller 52 until the side rails 34 are in the acceptable state. If the start control 230 is pressed prior to the side rails 34 being in the acceptable state, the controller 52 can provide an additional notification to the user, such as a color change or a light flash at screen 220, or an audible alert via a speaker on the user interface 48. Alternatively, the start control 230 is not provided at screen 220, and the controller 52 automatically returns to turn assist screen 214 once the side rails 34 reach the acceptable state, and the user can select the start control 218 from turn assist screen 214. Screen 220 also includes a cancel icon 232 that allows the user to return to the turn assist screen 214 (FIG. 11) or the menu screen 116 (FIG. 4) without changing the position of the side rails 34. Alternatively, instead of or in addition to the cancel icon 232, touch input anywhere outside of the boundaries of screen 220 on the touchscreen 58 removes the screen 220 in embodiments where screen 220 is smaller than the display area of the touchscreen 58.

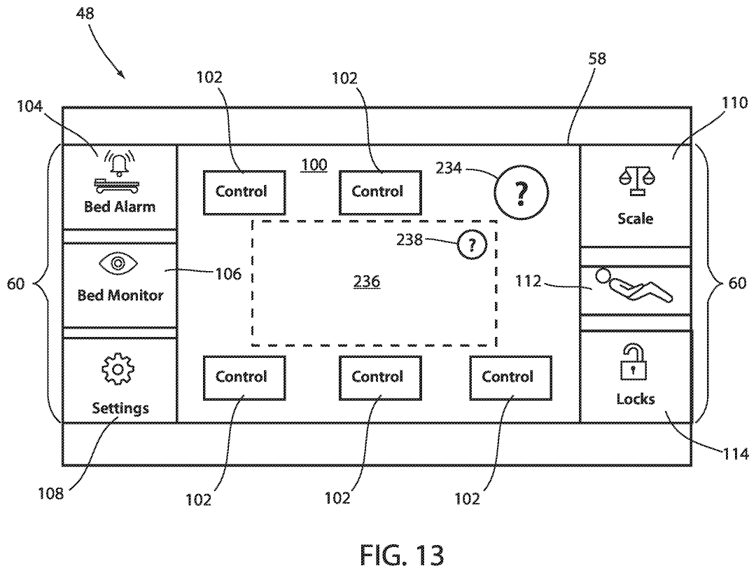

Referring to FIG. 13, the user interface 48 provides several help functions via the touchscreen 58 that give the user direct access to help from at least some of the screens 100 displayed at the touchscreen 58, rather than requiring the user to navigate back to the main screen 116 and through several other steps via the help control 140 in order to find a particular help topic. Instead, help directly related to the current screen 100 can be accessed directly from the screen 100 itself. In particular, controller 52 is configured to display a help icon 234 on at least some screens 100 displayed at the touchscreen 58. Upon selection of the help icon 234 on the screen 100, an explanation overlay 236 is displayed at the touchscreen 58. The explanation overlay 236 includes text explaining the screen 100, such as explaining one or more icons, controls, or indicators shown in the screen 100. Advantageously, the explanation overlay 236 is partially transparent such that the screen 100 is at least partially visible under the explanation overlay 236 while the controller 52 is displaying the explanation overlay 236. Thus, even when extra information is provided, the user is not dissociated from their current task.

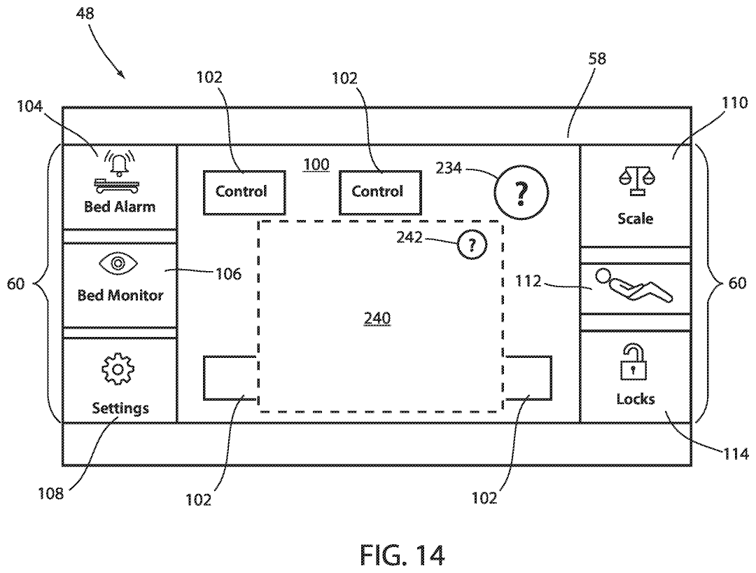

The explanation overlay 236 can include another help icon 238. Upon selection of the help icon 238 on the explanation overlay 236, another explanation overlay 240 is displayed at the touchscreen 58, as shown in FIG. 14. Advantageously, the second explanation overlay 240 includes different information than the information provided by the first explanation overlay 236, such as additional information or a more thorough explanation of the one or more icons, controls, or indicators shown in the screen 100. The second explanation overlay 240 can include yet another help icon 242 to display yet another explanation overlay (not shown) at screen 100. In this manner, multiple layers of help directly related to the current screen 100 displayed can be accessed via the touchscreen 58.

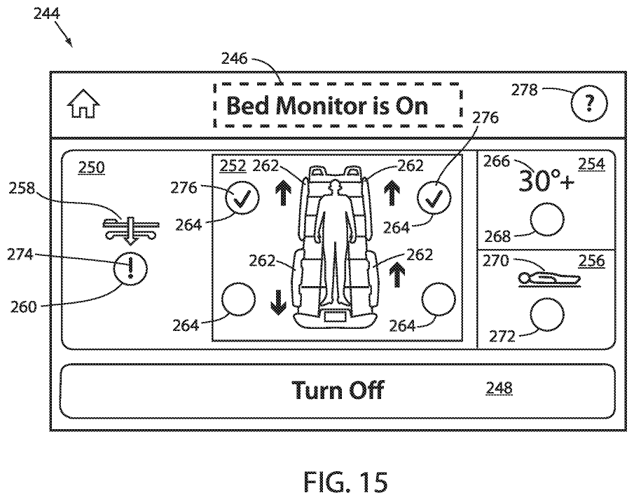

One specific example of these help functions is shown in FIGS. 15-18 with respect to the bed monitor system. Generally, the bed monitor system is used to monitor a selected state of at least one component of the patient support apparatus 10, and to generate an alert if the component changes out of the selected state. The alert may be local to the patient support apparatus 10 (e.g. emitting a light and/or a sound from patient support apparatus 20) or it may be remote (e.g. patient support apparatus 10 sends a message to a server, or other computer device (e.g. a smart phone), within the healthcare facility). In particular, the bed monitor system monitors one or more of the height or angular position of the litter frame 16 using readings from the lift sensor(s) 66, the angular position of the head section 20 using sensor readings from the head section position sensor 76, the angular position of the thigh section 24 using sensor readings from the thigh section position sensor 78, the angular position of the foot section 26 using sensor readings from the foot section position sensor 80, the position of the side rails 34 using readings from the side rail sensors 92, the movement of an occupant of the patient support apparatus 10 using readings from the force sensors 84, or the bed exit system.

When the bed monitor control 106 on the user interface 48 of FIG. 3 is selected or when the bed monitor control 124 on the menu screen 116 of FIG. 4 is selected, the controller 52 displays bed monitor screen 244, shown in FIG. 15, on touchscreen 58. The display of bed monitor screen 244 may occur immediately after the bed monitor control 106 or 124 is pressed, or there may be one or more intermediate controls/screens that need to be followed before getting to bed monitor screen 244. However arrived at, the display of bed monitor screen 244 includes an indicator 246 notifying the user of the current state of the bed monitor system, i.e. that the bed monitor function is turned on or off, as determined by the controller 52, including text and/or graphics describing the current state. In FIG. 15, the indicator 246 includes text indicating that the bed monitor function is currently on. Bed monitor screen 244 also includes a control icon 248 for changing the current state of the bed monitor system, i.e. for turning the bed monitor function on and off, including text and/or graphics describing the control. In FIG. 15, because the bed monitor function is depicted as currently on, the control icon 248 includes text indicating that the control icon 248 can be used to turn the bed monitor function off.

Bed monitor screen 244 of FIG. 15 also includes multiple icons 250, 252, 254, 256 for each of the components of the patient support apparatus 10 which can be monitored via the bed monitor system, including text, graphics, and/or colors indicating the component and its current state, including whether it is being monitored by the bed monitor system and whether it is currently in or out of its selected state or configuration.

Icon 250 includes a graphic 258 representing the height of the litter frame 16 and a control icon 260 for turning bed monitor on and off for the litter frame height. Icon 252 includes a graphic 262 representing each side rail 34 and a control icon 264 for turning bed monitor on and off for each side rail 34. Icon 254 includes a graphic 266 representing the setting for the head angle, as determined by the head section 20 of the support deck 18, which is shown herein as set for a 30 degree angle, and a control icon 268 for turning bed monitor on and off for the head angle. Icon 256 includes a graphic 270 representing the setting for the bed angle, as determined by the angle of the litter frame 16 and deck sections 20-26 and which is shown herein as set for a flat bed angle, and a control 272 for turning bed monitor on and off for the bed position.

A separate screen (not shown) can include controls for selecting the state of each of the components of the patient support apparatus 10 which are monitored via the bed monitor system. Alternatively screen 244 can include such controls.

The controller 52 is configured to provide visual feedback regarding which components are currently selected for monitoring via the bed monitor system, such as text, graphics, and/or colors indicating which components are currently being monitored. In FIG. 15, the height of the litter frame 16 and the position of the upper side rails 34 is being monitored, and is indicated by showing the icons 250 and 252 in a different color than icons 254 and 256.

Of the components currently being monitored, the controller 52 is further configured to provide a visual alert to notify the user which components are out of the selected state, such as by showing a particular graphic or changing a color of the associated icon on screen 244. The controller 52 can also provide an audible alert via speaker on the user interface 48 or elsewhere on the apparatus 10. The alerts are generated by the controller 52 based at least in part on readings from one or more of the sensors 66, 76, 78, 80, 84, 92. In FIG. 15, the height of the litter frame 16 is out of the selected state, and icon 250 includes an alert graphic 274. Also in FIG. 15, the position of the upper side rails 34 is compliant or in the selected state, and icon 252 includes check graphics 276 indicating compliance for the upper side rails 34.

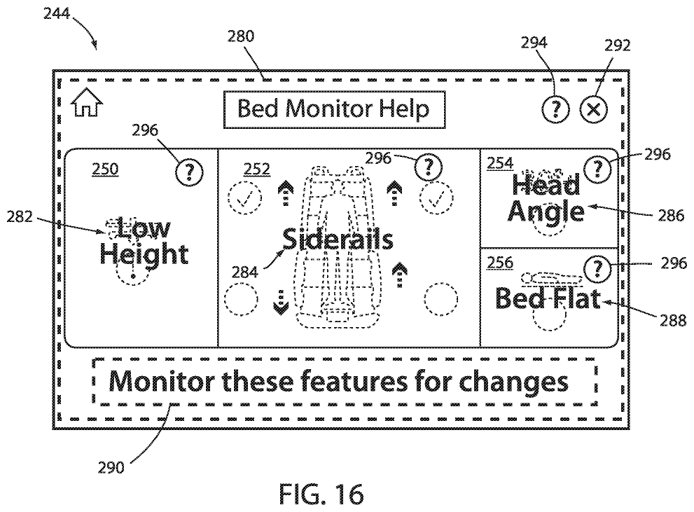

Bed monitor screen 244 also includes a help icon 278. Upon selection of the help icon 278, an explanation overlay 280 is displayed, as shown in FIG. 16. The explanation overlay 280 includes text explaining the bed monitor screen 244, such as explaining one or more of the indicators 246, controls 248, and/or icons 250-256 shown in the screen 244.

The explanation overlay 280 is partially transparent such that the screen 244 is at least partially visible under the explanation overlay 280 while the controller 52 is displaying the explanation overlay 280. In FIG. 16, at least a portion of the icons 250-256 are still partially visible under the explanation overlay 280, which provides a visual association between the explanation and content on the screen 244. Specifically, the explanation overlay 280 includes text overlaid on each of the icons 250-256 which explains the icons 250-256 it overlays, including text 282 explaining the icon 250 relating to the height of the litter frame 16, text 284 explaining the icon 252 relating to the positional status of the side rails 34, text 286 explaining the icon 254 relating to the head angle, and text 288 explaining the icon 256 relating to the bed angle. The explanation overlay 280 further includes text 290 explaining the general function of the bed monitor system.

While the explanation overlay 280 is displayed, the controller 52 disables one or more controls on the screen 244. The explanation overlay 280 also includes a cancel icon 292 that removes the explanation overlay 280. Upon user-selection of the cancel icon 292, the controller 52 enables the screen 244. Alternatively, instead of or in addition to the cancel icon 292, touch input anywhere outside of the boundaries of overlay 280 on the touchscreen 58 can remove the overlay 280 in cases where the overlay 280 is smaller than the display area of the touchscreen 58.

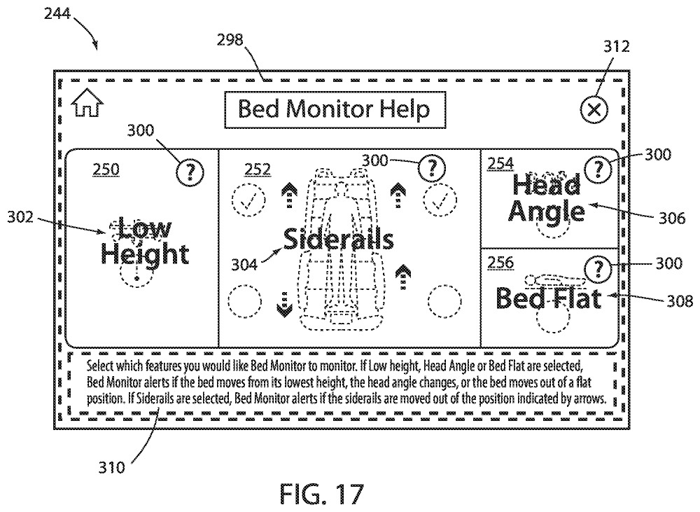

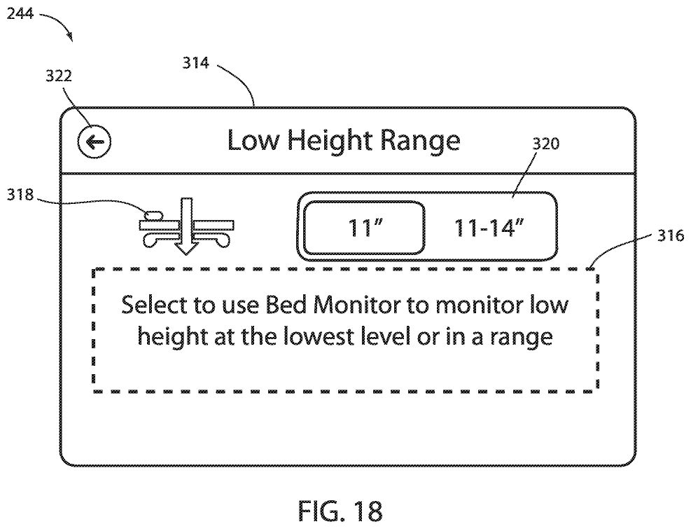

The explanation overlay 280 further includes one or more additional help icons, including a general help icon 294 and multiple specific help icons 296. Upon selection of the help icon 294 on the explanation overlay 280, another explanation overlay 298 is displayed at the touchscreen 58, as shown in FIG. 17. Advantageously, the second explanation overlay 298 includes different information than the information provided by the first explanation overlay 280, such as additional information or a more thorough explanation of one or more of the indicators 246, controls 248, and/or icons 250-256 shown in the screen 244. The second explanation overlay 298 can include yet another help icon 300 to display yet another explanation overlay, one example of which is shown in FIG. 18, with further information at screen 244. In this manner, multiple layers of help directly related to the bed monitor screen 244 can be accessed via the touchscreen 58.

The second explanation overlay 298 is partially transparent such that the screen 244 is at least partially visible under the explanation overlay 298 while the controller 52 is displaying the explanation overlay 298. In FIG. 17, at least a portion of the icons 250-256 are still partially visible under the explanation overlay 298, which provides a visual association between the explanation and content on the screen 244. Specifically, the explanation overlay 298 includes text overlaid on each of the icons 250-256 which explains the icons 250-256 it overlays, including text 302 explaining the icon 250 relating to the height of the litter frame 16, text 304 explaining the icon 252 relating to the positional status of the side rails 34, text 306 explaining the icon 254 relating to the head angle, and text 308 explaining the icon 256 relating to the bed angle.

The explanation overlay 298 further includes text 310 explaining the general function of the bed monitor system. In FIG. 17, the text 310 explaining the general function of the bed monitor system differs from the text 290 shown in the first explanation overlay 280. The text 310 includes additional information and a more thorough explanation of the bed monitor system.

Portions of the second explanation overlay 298 can be the same or substantially the same as that of the first explanation overlay 280. In FIG. 17, the text 302-308 relating to the specific components which can be monitored by the bed monitor system is the same as the text 282-288 of the first explanation overlay 280 shown in FIG. 16. Alternatively, the text 302-308 can be different, and can include additional information and a more thorough explanation of the components which can be monitored by the bed monitor system.

While the explanation overlay 298 is displayed, the controller 52 disables one or more controls on the screen 244. The explanation overlay 298 also includes a cancel icon 312 that removes the explanation overlay 298. Upon user-selection of the cancel icon 312, the controller 52 enables the screen 244. Alternatively, instead of or in addition to the cancel icon 312, touch input anywhere outside of the boundaries of overlay 298 on the touchscreen 58 can remove the overlay 298 in cases where the overlay 298 is smaller than the display area of the touchscreen 58.

Returning to FIG. 16, upon selection of one of the specific help icons 296 on the explanation overlay 280, another explanation overlay 314 specific to one of the components that can be monitored by the bed monitor system is displayed at the touchscreen 58, as shown in FIG. 18. Advantageously, the explanation overlay 314 includes different information than the information provided by the first explanation overlay 280, such as specific detailed information on one of the icons 250-256 shown in the screen 244. In this manner, specific help directly related to the components that can be monitored by the bed monitor system can be accessed via the touchscreen 58. While not shown herein, the explanation overlay 314 can be partially transparent such that the screen 244 is at least partially visible under the explanation overlay 314 while the controller 52 is displaying the explanation overlay 314.

The explanation overlay 314 includes text 316 explaining the general function of the bed monitor system for the selected component and a graphic 318 representing the selected component. In FIG. 18, the text 316 explains the height setting of the bed monitor system, and includes additional information and a more thorough explanation that provided in the other explanation overlays 280, 298. The graphic 318 represents the litter frame height. The explanation overlay 314 can include yet another help icon (not shown) to display yet another explanation overlay with further information at screen 244.

The explanation overlay 314 further includes a control icon 320 for changing selected state or configuration of the component. In FIG. 18, the control icon 320 changes the selected low height setting for the litter frame 16. While not shown herein, any of the other explanation overlays 280, 298 can include one or more similar control icons as well.

While the explanation overlay 314 is displayed, the controller 52 disables one or more controls on the screen 244. The explanation overlay 314 also includes a cancel icon 322 that removes the explanation overlay 314. Upon user-selection of the cancel icon 322, the controller 52 enables the controls on screen 244. Alternatively, instead of or in addition to the cancel icon 322, touch input anywhere outside of the boundaries of overlay 314 on the touchscreen 58 can remove the overlay 314 in cases where the overlay 314 is smaller than the display area of the touchscreen 58.

Referring to FIGS. 3, 4, and 19, rather than requiring the user to navigate through multiple explanation overlays to reach a desired level of help, in some embodiments the user interface 48 is configured to allow a user to select a user expertise level via the touchscreen 58, such that an explanation overlay configured for the selected user expertise level is displayed upon a the selection of a help icon.

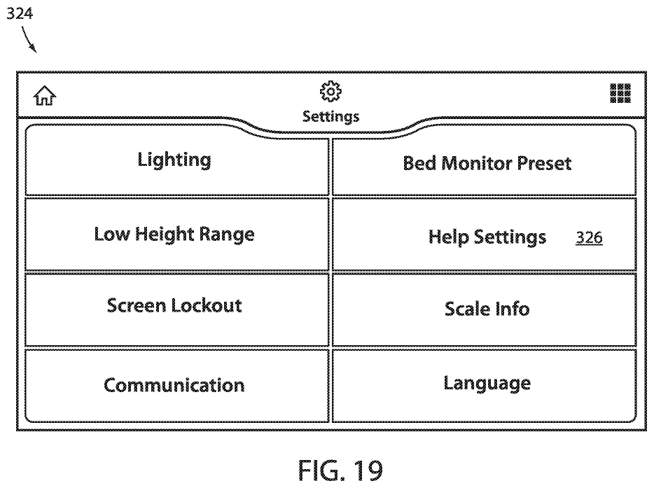

When the settings control 108 on the user interface 48 of FIG. 3 is selected or when the settings control 126 on the menu screen 116 of FIG. 4 is selected, the controller 52 displays settings screen 324, shown in FIG. 19, on touchscreen 58. The display of settings screen 324 may occur immediately after the settings control 108 or 126 is pressed, or there may be one or more intermediate controls/screens that need to be followed before getting to settings screen 324. However arrived at, the display of settings screen 324 includes a plurality of touchscreen controls, including at least a help settings control 326.

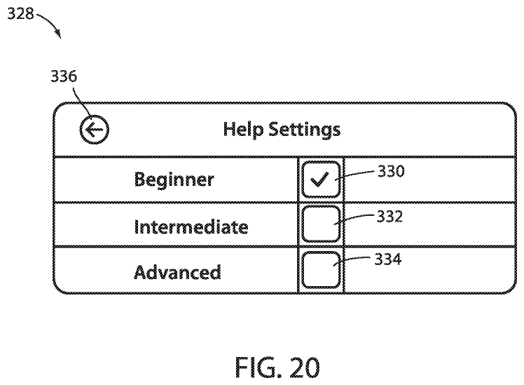

User selection of help settings control 326 displays help settings screen 328 on the touchscreen 58, shown in FIG. 20. The display of help settings control 326 may occur immediately after the help settings control 326 of FIG. 19 is pressed, or there may be one or more intermediate controls/screens that need to be followed before getting to help settings screen 328. However arrived at, the display of help settings screen 328 includes input controls 330, 332, 334 for selecting a user expertise level from at least a first user expertise level and a second user expertise level. In FIG. 20, three user expertise levels can be selected, including beginner, intermediate, and advanced. An input control 330, 332, 334 is provided for each expertise level, and selecting one of the input controls will deselect the other input controls.

The controller 52 can be configured to provide visual feedback regarding which user expertise level is currently selected, such as text, graphics, and/or colors on screen 328. In FIG. 20, the beginner level is selected, and is indicated by showing the input control 330 for the beginner level in a different graphic and color than for the other input controls 332, 334.

Upon selection of one of the user expertise levels on screen 328, the controller 52 is configured to display an explanation overlay configured for the selected user expertise level upon the selection of a help icon. For example, with the input control 334 for the advanced level selected on screen 328 of FIG. 20, upon the selection of help icon 234 on screen 100 of FIG. 13, the displayed explanation overlay 236 is configured for an advanced level user who needs little explanation. If the input control 334 for the intermediate level is selected on screen 328 of FIG. 20, upon the selection of help icon 234 on screen 100 of FIG. 13, the controller 52 instead displays explanation overlay 240 (FIG. 14) which has additional information and is configured for an intermediate level user. Explanation overlay 240 is displayed without requiring the user to navigate through the advanced level overlay 236 first.

In another example, with reference to FIG. 15, upon selection of the help icon 278 on the bed monitor screen 244, the controller 52 displays the first explanation overlay 280 (FIG. 16) if the advanced level is selected and displays the second explanation overlay 298 (FIG. 17) if the intermediate level is selected, and displays an even more detailed explanation overlay (not shown) if the beginner level is selected.

Screen 328 also includes a back icon 336 that allows the user to return to the settings screen 324 (FIG. 19) or the menu screen 116 (FIG. 4). Alternatively, instead of or in addition to the back icon 336, touch input anywhere outside of the boundaries of screen 328 on the touchscreen 58 can remove the screen 328 in cases where the screen 328 is smaller than the display area of the touchscreen 58.

To the extent not already described, the different systems and structures of the patient support apparatus 10 may be used in combination with each other as desired. That one patient support apparatus 10 is illustrated as having all systems and structures disclosed herein is not to be construed that it must have all of the systems and structures, but is done for brevity of description. For example, embodiments of the selective numeric content display (e.g., FIGS. 5-6), the selective provision of a control icon to move the patient support apparatus 10 into an acceptable state for carrying out a selected function (e.g., FIGS. 7-12), the explanation overlays (e.g. FIGS. 13-18), and the selection of a user expertise level (e.g., FIGS. 19-20) can be implemented independently of each other or in any sub-combination on the patient support apparatus 10. Likewise, the lift system 62, articulation system 68, scale system 82, side rail system 88, and mattress system can be provided independently of each other or in any sub-combination on the patient support apparatus 10.

It will be understood that any of the various embodiments of patient support apparatus 10 can also be modified to include, either in addition to, or in lieu of, any one or more of the features described herein, any one or more of the features described in commonly assigned U.S. patent applications Ser. No. 16/229,108, filed on Dec. 21, 2018, and entitled PATIENT SUPPORT APPARATUS USER INTERFACES, and/or U.S. provisional patent application Ser. No. 62/783,305 filed on Dec. 21, 2018, and entitled USER MODULE FOR A PATIENT SUPPORT APPARATUS, the complete disclosures of both of which are incorporated herein by reference.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

1. A patient support apparatus comprising:
a litter frame;
a support deck supported on the litter frame and adapted to support a patient thereon, the litter frame including a plurality of sections;
an actuator adapted to move a component of the patient support apparatus;
a sensor adapted to detect a configuration of the component;
a touchscreen; and
a controller in operative communication with the sensor and the touchscreen and configured to receive readings from the sensor, the controller configured to generate a first control screen and a second control screen at the touchscreen wherein the first control screen includes a first control icon for controlling the component and the second control screen includes a second control icon for controlling a function;
wherein, in response to a user selecting the second control icon, the controller is configured to determine if a current configuration of the component is in an acceptable state or an unacceptable state for carrying out the function, and if the controller determines the component is currently in the unacceptable state, the controller is further configured to display a third control icon, the third control icon allowing the user to move the component to the acceptable state without accessing the first control screen.

2. The patient support apparatus of claim 1, wherein the component is the litter frame, the acceptable state is the litter frame being level, the unacceptable state is the litter frame being non-level, the function is weighing a patient supported on the support deck, and the third control icon comprises a one-touch input control for moving the litter frame to a level configuration.

3-5. (canceled)

6. The patient support apparatus of claim 1, wherein the support deck comprises a head section the component is the head section, and the third control icon comprises an input control for adjusting a position of the head section, and the acceptable state is the head section being within a predetermined range of angular positions.

7-8. (canceled)

9. The patient support apparatus of claim 6, wherein the acceptable state is the head section being below an angular threshold, the unacceptable state is the head section being at or above the angular threshold, the angular threshold is 60 degrees with respect to horizontal, and the function is lateral rotation of a patient supported on the support deck.

10-11. (canceled)

12. The patient support apparatus of claim 9, wherein the acceptable state is the head section being below an angular threshold, the unacceptable state is the head section being at or above the angular threshold, the angular threshold is zero degrees with respect to horizontal, and the function is weighing a patient supported on the support deck.

13. (canceled)

14. The patient support apparatus of claim 1, wherein the function is at least one of: weighing a patient supported on the support deck, turning a patient supported on the support deck, or lateral rotation of a patient supported on the support deck; wherein the sensor is adapted to detect at least one of: a position of a head section of the support deck, a position of a thigh section of the support deck, a position of a foot section of the support deck, movement of a patient supported on the support deck, a positional status of a side rail of the litter frame, or a height of the litter frame; and wherein the actuator comprises at least one of:
a lift actuator adapted to raise and lower the litter frame, a head section actuator adapted to control an angle of the head section of the support deck, a thigh section actuator adapted to control an angle of the thigh section of the support deck, or a foot section actuator adapted to control an angle of the foot section of the support deck.

15. The patient support apparatus of claim 1, wherein if the component is in an acceptable state, the controller is further configured to display the second control screen without the third control icon.

16-19. (canceled)

20. The patient support apparatus of claim 1, wherein the controller is configured to display the third control icon in a pop-up window, wherein the second control screen is at least partially visible behind the pop-up window, and wherein the controller is further configured to display a cancel icon simultaneously with the third control icon, the cancel icon allowing the user to remove the pop-up window.

21. (canceled)

22. The patient support apparatus of claim 1, wherein the controller is configured to display the third control icon on a third control screen, different from the first and second control screens; wherein if the controller determines the component is currently in the unacceptable state, the controller is further configured to display an error message on the third control screen simultaneously with the third control icon; and wherein the error message comprises an indicator of the current configuration of the component and an indicator of the acceptable state for the component for carrying out the function.

23-25. (canceled)

26. A patient support apparatus comprising:
a litter frame;
a support deck supported on the litter frame and adapted to support a patient thereon;
a touchscreen; and
a controller configured to display a first screen at the touchscreen, the first screen including a first icon and a help icon, the controller further configured to display an explanation overlay at the touchscreen in response to user-selection of the help icon, the explanation overlay comprising text explaining the first icon and the explanation overlay being partially transparent such that the first screen is at least partially visible under the explanation overlay while the controller is displaying the explanation overlay.

27. The patient support apparatus of claim 26, wherein the first icon controls a component or a function of the patient support apparatus, the controller is configured to disable the first icon if the explanation overlay is displayed at the touchscreen, and the explanation overlay further comprises a cancel icon allowing a user to return to the first screen.

28. (canceled)

29. The patient support apparatus of claim 26, wherein the controller is further configured to overlay the text explaining the first icon on the first icon and wherein the first screen comprises an additional icon, and the explanation overlay comprises text explaining the additional icon that is simultaneously displayed with the text explaining the first icon.

30. (canceled)

31. The patient support apparatus of claim 26, wherein the first screen is a patient support apparatus monitor screen including a control for arming a patient support apparatus monitoring function, wherein the patient support apparatus monitoring function is adapted to monitor a selected state of a component of the patient support apparatus and to generate an alert if the component changes out of the selected state; and wherein the first icon comprises an indicator of at least one of patient support apparatus height, side rail position, head angle, or litter frame position.

32. (canceled)

33. The patient support apparatus of claim 26, further comprising a sensor adapted to detect a configuration of a component of the patient support apparatus, wherein the controller is in operative communication with the sensor and configured to receive readings from the sensor, wherein the first icon is at least partially based on the readings from the sensor, and wherein the sensor is adapted to detect at least one of: a position of a head section of the support deck, a position of a thigh section of the support deck, a position of a foot section of the support deck, movement of a patient supported on the support deck, a positional status of a side rail of the litter frame, or a height of the litter frame.

34. (canceled)

35. The patient support apparatus of claim 33, further comprising an actuator adapted to move the component of the patient support apparatus, wherein the actuator comprises at least one of: a lift actuator adapted to raise and lower the litter frame, a head section actuator adapted to control an angle of the head section of the support deck, a thigh section actuator adapted to control an angle of the thigh section of the support deck, or a foot section actuator adapted to control an angle of the foot section of the support deck.

36. (canceled)

37. A patient support apparatus comprising:
a litter frame;
a support deck supported on the litter frame and adapted to support a patient thereon;
a touchscreen; and
a controller configured to display on the touchscreen:
a first screen including a first icon and a first help icon;
a first explanation overlay including a second help icon and first information explaining the first icon; and
a second explanation overlay including second information explaining the first icon; and
wherein the controller is operable to display the first explanation overlay in response to selection of the first help icon and to display the second explanation overlay in response to selection of the second help icon.

38. (canceled)

39. The patient support apparatus of claim 37, wherein the first information comprises first text explaining the first icon, and the second information comprises second text, different from the first text, explaining the first icon.

40. (canceled)

41. The patient support apparatus of claim 37, wherein at least one of the first explanation overlay or the second explanation overlay is partially transparent such that the first screen is at least partially visible under the at least one of the first explanation overlay or the second explanation overlay while the controller is displaying the at least one of the first explanation overlay or the second explanation overlay, and wherein the first icon controls a component or a function of the patient support apparatus, and the controller is configured to disable the first icon if either the first explanation overlay or the second explanation overlay is displayed on the touchscreen.

42. (canceled)

43. The patient support apparatus of claim 37, wherein the first explanation overlay further comprises a cancel icon allowing a user to return to the first screen.

44-47. (canceled)

48. The patient support apparatus of claim 37, further comprising a sensor adapted to detect a configuration of a component of the patient support apparatus, and an actuator adapted to move the component of the patient support apparatus; wherein the controller is in operative communication with the sensor and configured to receive readings from the sensor, wherein the first icon is at least partially based on the readings from the sensor and the sensor is adapted to detect at least one of: a position of a head section of the support deck, a position of a thigh section of the support deck, a position of a foot section of the support deck, movement of a patient supported on the support deck, a positional status of a side rail of the litter frame, or a height of the litter frame; and wherein the actuator comprises at least one of: a lift actuator adapted to raise and lower the litter frame, a head section actuator adapted to control an angle of the head section of the support deck, a thigh section actuator adapted to control an angle of the thigh section of the support deck, or a foot section actuator adapted to control an angle of the foot section of the support deck.

49-75. (canceled)
